(19) United States
(12) Patent Application Publication
(10) Pub. No.: US 2025/0036766 A1
(43) Pub. Date: Jan. 30, 2025

(54) ATTACK ANALYSIS DEVICE, ATTACK ANALYSIS METHOD, AND COMPUTER READABLE MEDIUM

(71) Applicant: Mitsubishi Electric Corporation, Tokyo (JP)

(72) Inventors: Yosuke YOKOYAMA, Tokyo (JP); Yoshiaki KATAYAMA, Tokyo (JP); Manabu MISAWA, Tokyo (JP); Kazuki YONEMOCHI, Tokyo (JP); Naoki UEDA, Tokyo (JP); Yuya HIRAI, Tokyo (JP)

(73) Assignee: Mitsubishi Electric Corporation, Tokyo (JP)

(21) Appl. No.: 18/916,046

(22) Filed: Oct. 15, 2024

Related U.S. Application Data
(63) Continuation of application No. PCT/JP2022/022239, filed on Jun. 1, 2022.

(51) Int. Cl. G06F 21/56

(52) U.S. Cl. CPC G06F 21/566; G06F 2221/034

(57) ABSTRACT

A data acquisition unit (21) acquires operation data including an influence-source object being an object which has performed an operation to influence another object, an influence-destination object being an object influenced by the operation performed by the influence-source object, and an attack probability representing a probability of the operation being an attack. A relation construction unit (22) constructs relation data when the attack probability is equal to or higher than a threshold value A, by adding a relation between the influence-source object and the influence-destination object to relation data. When an attack is detected, a specification unit (23) specifies at least either of an infected range supposed to be affected by the attack, and an intrusion route of the attack, based on the relation data.

### CROSS REFERENCE TO RELATED APPLICATION

This application is a Continuation of PCT International Application No. PCT/JP2022/022239, filed on Jun. 1, 2022, which is hereby expressly incorporated by reference into the present application.

### TECHNICAL FIELD

The present disclosure relates to a technique to specify an infected range supposed to be affected by a cyber attack.

### BACKGROUND ART

Patent Literature 1 discloses a technique to specify an intrusion route and an infected range due to an attack in a system which has received a cyber attack. In Patent Literature 1, relation data between objects is generated from operation data of a plurality of pieces of software. Then, when a cyber attack is detected, the intrusion route and the infected range are specified based on the relation data.

The relation data is a directed graph. The directed graph includes objects as nodes. The directed graph includes directed edges from influence-source objects to influence-destination objects corresponding to operation data having an influence on relations between the objects. When the cyber attack is detected, the relation data is referred to. A range obtained by tracing the directed edges from an object where the attack is detected in a reverse direction is specified as the intrusion route. The range obtained by tracing edges in a forward direction is specified as the infected range.

### CITATION LIST

### Patent Literature

Patent Literature 1: JP6987332 B1

### SUMMARY OF INVENTION

### Technical Problem

Patent Literature 1 generates relation data between objects from operation data of a plurality of pieces of software. In this case, relation data with respect to operations irrelevant to cyber attacks is also generated. Therefore, when the relation data is traced in a reverse direction or in a forward direction when a cyber attack is received, an object nothing to do with the cyber attack may be reached. As a result, a part that is not an intrusion route or an infected range may be specified as the intrusion route or the infected range.

This disclosure is aimed at making it possible to specify an object highly likely to be related to a cyber attack as at least either of the intrusion route and the infected range.

### Solution to Problem

An attack analysis device according to the present disclosure includes:
a data acquisition unit to acquire operation data including at least an influence-destination object and an attack probability among an influence-source object being an object which has performed an operation to influence another object, the influence-destination object being an object which is influenced by the operation performed by the influence-source object, and the attack probability representing a probability of the operation being an attack;
a relation construction unit to construct relation data when the operation data acquired by the data acquisition unit includes the influence-source object, and the attack probability is equal to or higher than a threshold value A, by adding a relation between the influence-source object and the influence-destination object to the relation data; and
a specification unit to specify at least either of an infected range which is supposed to be affected by an attack that is detected, and an intrusion route of the attack detected, based on the relation data constructed by the relation construction unit, when the attack is detected.

### Advantageous Effects of Invention

In the present disclosure, when a probability of an attack is equal to or higher than a threshold value A, a relation between an influence-source object and an influence-destination object is added to relation data, and the relation data is constructed. In this manner, it is possible to specify only an object which is highly likely to be related to a cyber attack as the intrusion route or the infected range.

### BRIEF DESCRIPTION OF DRAWINGS

FIG. 1 is a configuration diagram of an attack analysis device 10 according to a first embodiment;

FIG. 2 is an explanatory drawing of operation data 31 according to the first embodiment;

FIG. 3 is an explanatory drawing of a threshold value 41 according to the first embodiment;

FIG. 4 is an explanatory drawing of relation data 51 according to the first embodiment;

FIG. 5 is a flowchart of a relation construction process according to the first embodiment;

FIG. 6 is a flowchart of a specification process according to the first embodiment;

FIG. 7 is a configuration diagram of an attack analysis device 10 according to a first variation;

FIG. 8 is an explanatory drawing of history data 61 according to a second embodiment;

FIG. 9 is a flowchart of a relation construction process according to the second embodiment;

FIG. 10 is a configuration diagram of an attack analysis device 10 according to a third embodiment;

FIG. 11 is an explanatory drawing of operation data 31 according to a third embodiment; and

FIG. 12 is a flowchart of an attack probability calculation process according to the third embodiment.

### DESCRIPTION OF EMBODIMENTS

### First Embodiment

### Description of Configuration

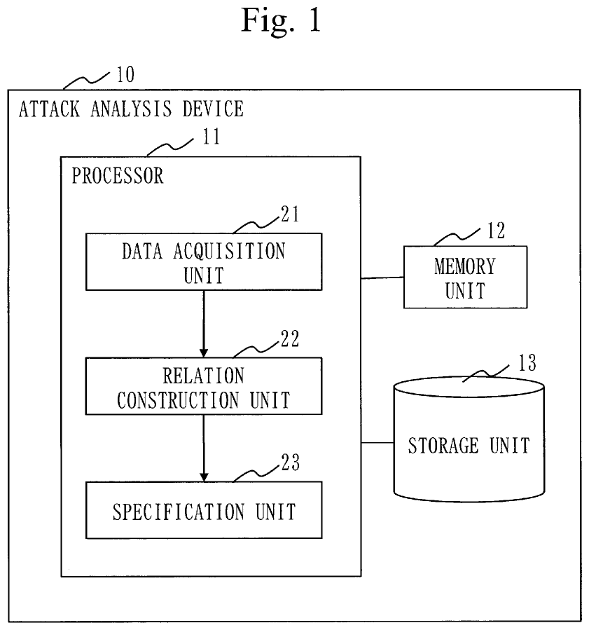

Description will be made on a configuration of an attack analysis device 10 according to a first embodiment with reference to FIG. 1.

The attack analysis device 10 is a computer.

The attack analysis device 10 includes hardware components of a processor 11, a memory unit 12 and a storage unit 13. The processor 11 is connected to the other hardware components via a signal line, and controls these other hardware components.

The processor 11 is an IC to perform processing. IC is an abbreviation for Integrated Circuit. The processor 11 is, for example, a CPU, a DSP or a GPU. CPU is an abbreviation for Central Processing Unit. DSP is an abbreviation for Digital Signal Processor. GPU is an abbreviation for Graphics Processing Unit.

The memory unit 12 is a volatile storage device to temporarily store data. The memory unit 12 is, for example, an SRAM or a DRAM. SRAM is an abbreviation for Static Random Access Memory. DRAM is an abbreviation for Dynamic Random Access Memory.

The storage unit 13 is a non-volatile storage device to store data. The storage unit 13 is, for example, an HDD. HDD is an abbreviation for Hard Disk Drive. Further, the storage unit 13 may be a portable recording medium such as an SD (registered trademark) memory card, a CompactFlash (registered trademark), a NAND flash memory, a flexible disk, an optical disk, a compact disk, a Blue-ray (registered trademark) disk, a DVD or the like. SD is an abbreviation for Secure Digital. DVD is an abbreviation for Digital Versatile Disk.

The attack analysis device 10 is equipped with a data acquisition unit 21, a relation construction unit 22 and a specification unit 23 as functional components. The functions of each functional component of the attack analysis device 10 are realized by software.

In the storage unit 13, programs to realize the functions of each functional component of the attack analysis device 10 are stored. These programs are read into the memory unit 12 by the processor 11, and executed by the processor 11. In this manner, the functions of each functional component of the attack analysis device 10 are realized.

In FIG. 1, only one processor 11 is illustrated. However, there may be a plurality of processors 11, and the plurality of processors 11 may cooperate with one another and execute the programs to realize each function.

### Description of Operation

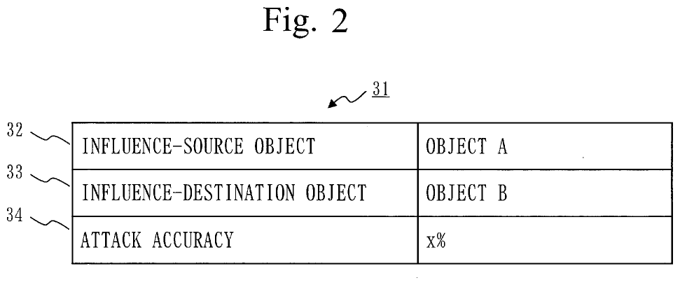

The operation of the attack analysis device 10 according to First Embodiment will be described with reference to FIG. 2 through FIG. 6.

The operation procedure of the attack analysis device 10 according to First Embodiment corresponds to an attack analysis method according to First Embodiment. Further, the programs to realize the operation of the attack analysis device 10 according to First Embodiment corresponds to an attack analysis program according to First Embodiment.

The operation of the attack analysis device 10 includes a relation construction process and a specification process. After describing data and the like used in the relation construction process and the specification process, the relation construction process and the specification process will be described.

Description will be made on the operation data 31 according to First Embodiment with reference to FIG. 2.

The operation data 31 represents an operation in a case in which a certain object in a system performs the operation that influences another object, in the system being a target. The target system is a system being a target to be specified at least either of an intrusion route and an infected range. Objects are elements that are used when software is executed. The objects are, for example, elements such as a process, a file and a shared memory area.

The operation data 31 includes an influence-source object 32, an influence-destination object 33 and an attack probability 34.

The influence-source object 32 is an object that has performed an operation to influence another object. The influence-destination object 33 is an object influenced by the operation performed by the influence-source object 32. It is assumed that data is transmitted from a process A to a process B. In this case, the influence-source object 32 is the process A. The influence-destination object 33 is the process B. It is assumed that data is written in a file D from a process C. In this case, the influence-source object 32 is the process C. The influence-destination object 33 is the file D.

The attack probability 34 represents a probability that the operation is a cyber attack against the target system.

The operation data 31 is generated by, for example, an intrusion detection program or a security monitoring program introduced in the target system.

It is also acceptable that the influence-source object 32 is not included in the operation data 31. In a case in which the intrusion detection program and the like that generates the operation data 31 is incapable of specifying the influence source, etc., the influence-source object 32 shall be not included in the operation data 31.

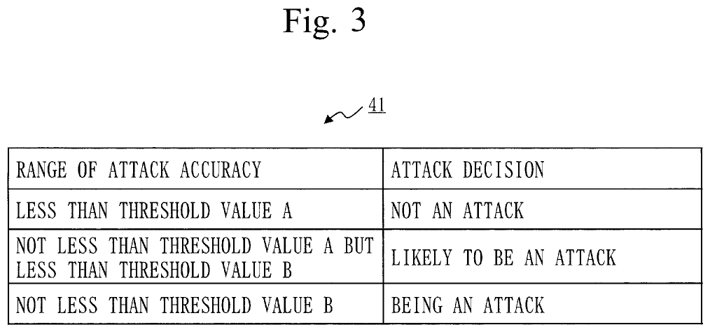

Description will be made on a threshold value 41 according to First Embodiment with reference to FIG. 3.

The threshold value 41 is information to classify the operations represented by the operation data 31 into three types of “not an attack”, “likely to be an attack” and “being an attack” according to the attack probability 34. Herein, the threshold value 41 represents that the operation is classified as “not an attack” when the attack probability 34 is lower than the threshold value A. The threshold value 41 represents that the operation is classified as “likely to be an attack” when the attack probability 34 is equal to or higher than the threshold value A but lower than the threshold value B. The threshold value 41 represents that the operation is classified as “being an attack” when the attack probability 34 is equal to or higher than the threshold value B.

The threshold value 41 is set in programs of the relation construction unit 22 and the specification unit 23. Otherwise, the threshold value 41 may be set in the storage unit 13.

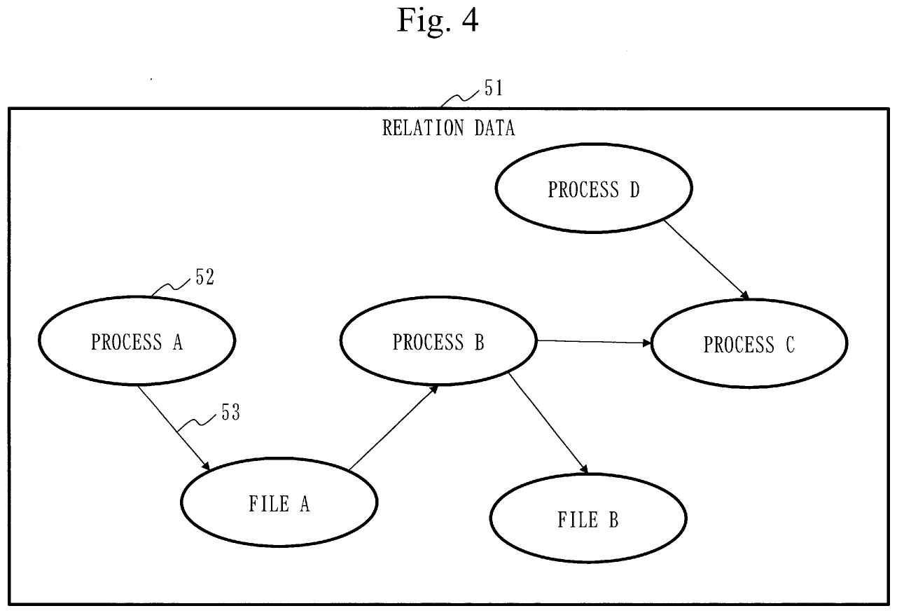

Description will be made on relation data 51 according to First Embodiment with reference to FIG. 4.

The relation data 51 is a directed graph constituted by a node 52 representing an object and an edge 53 having a direction toward an influence-destination object from an influence-source object. In FIG. 4, the node 52 is expressed by an elliptical shape. The edge 53 is represented by an arrow. The relation data 51 is stored in the memory unit 12 or the storage unit 13.

The relation data 51 is generated from the operation data 31. FIG. 4 shows operation data 31 in which the influence-source object 32 is the process A, and the influence-destination object 33 is the file A. There is shown operation data 31 in which the influence-source object 32 is the file A, and the influence-destination object 33 is the process B. There is shown operation data 31 in which the influence-source object 32 is the process B, and the influence-destination object 33 is the file B. There is shown operation data 31 in which the influence-source object 32 is the process B, and the influence-destination object 33 is the process C. There is shown operation data 31 in which the influence-source object 32 is the process D, and the influence-destination object 33 is the process C.

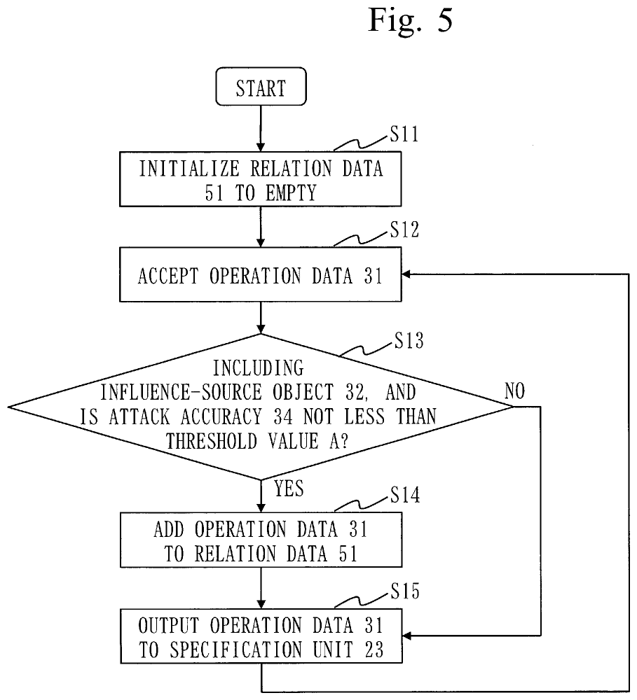

Description will be made on a relation construction process according to First Embodiment with reference to FIG. 5.

### (Step S11: Relation Data Initialization Process)

The relation construction unit 22 initializes the relation data 51 to empty. That is, the relation construction unit 22 brings the relation data 51 into a state not including a node 52 nor an edge 53.

### (Step S12: Operation Data Input Process)

The relation construction unit 22 accepts new operation data 31 as an input.

Specifically, the data acquisition unit 21 acquires operation data 31 newly generated. The operation data 31 acquired herein includes at least an influence-destination object 33 and an attack probability 34 among an influence-source object 32, the influence-destination object 33 and the attack probability 34. The data acquisition unit 21 inputs the operation data 31 acquired in the relation construction unit 22. The relation construction unit 22 accepts the operation data 31 input.

### (Step S13: Data Decision Process)

The relation construction unit 22 decides whether the operation data 31 accepted in Step S12 includes the influence-source object 32, and whether the attack probability 34 is equal to or higher than the threshold value A.

When the operation data 31 includes the influence-source object 32, and the attack probability 34 is equal to or higher than the threshold value A, the relation construction unit 22 proceeds with the process to Step S14. The attack probability 34 being equal to or higher than the threshold value A means that the operation is classified as “likely to be an attack” or “being an attack”. Meanwhile, in other case, the relation construction unit 22 proceeds with the process to Step S15.

### (Step S14: Data Addition Process)

The relation construction unit 22 adds a relation between the influence-source object 32 and the influence-destination object 33 in the operation data 31 accepted in Step S12 to the relation data 51. In this manner, the relation construction unit 22 constructs the relation data 51.

Specifically, the relation construction unit 22 adds direction information indicating a direction from the influence-source object 32 to the influence-destination object 33 to the relation data 51. Herein, the relation data 51 is a directed graph. Therefore, the relation construction unit 22 adds an edge 53 directed from a node 52 corresponding to the influence-source object 32 to a node 52 corresponding to the influence-destination object 33, as the direction information, to the relation data 51.

More specifically, the relation construction unit 22 decides whether the influence-source object 32 exists in the relation data 51. When the influence-source object 32 does not exist in the relation data 51, the relation construction unit 22 adds the node 52 corresponding to the influence-source object 32 to the relation data 51. Similarly, the relation construction unit 22 decides whether the influence-destination object 33 exists in the relation data 51. When the influence-destination object 33 does not exist in the relation data 51, the relation construction unit 22 adds the node 52 corresponding to the influence-destination object 33 to the relation data 51. The relation construction unit 22 adds an edge 53 directed to a node corresponding to the influence-destination object 33 from the node 52 corresponding to the influence-source object 32.

### (Step S15: Output Process)

The relation construction unit 22 outputs the operation data 31 accepted in Step S12 to the specification unit 23. Then, the relation construction unit 22 returns the process to Step S12, and waits for the next operation data 31 to be input.

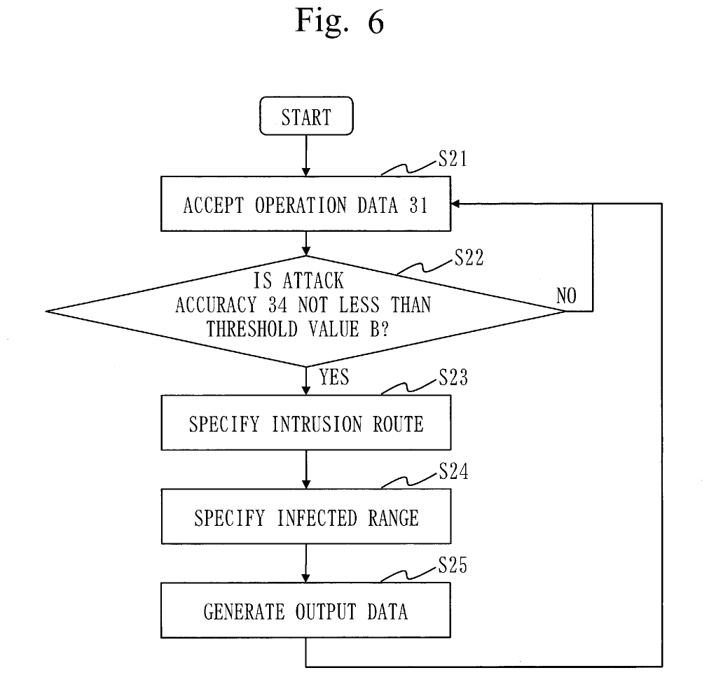

Description will be made on a specification process according to First Embodiment with reference to FIG. 6.

### (Step S21: Operation Data Input Process)

The specification unit 23 accepts new operation data 31 as an input. Specifically, the specification unit 23 accepts the operation data 31 output in Step S15.

### (Step S22: Data Decision Process)

The specification unit 23 decides whether an attack probability 34 in the operation data 31 accepted in Step S21 is equal to or higher than a threshold value B, or not.

When the attack probability 34 is equal to or higher than the threshold value B, the specification unit 23 proceeds with the process to Step S23. The attack probability 34 being equal to or higher than the threshold value B means that the operation is classified as “being an attack”. In other words, the attack probability 34 being equal to or higher than the threshold value B means that an attack against the target system is detected. In other cases, the specification unit 23 returns the process to Step S21, and waits for the next operation data 31 to be input.

### (Step S23: Intrusion Route Specification Process)

The specification unit 23 refers to the relation data 51 constructed by the relation construction unit 22, and specifies an intrusion route of the attack indicated by the operation data 31 accepted in Step S21.

Specifically, the specification unit 23 specifies an object in which an operation representing an attack indicated in the operation data 31 accepted in Step S21 is detected. Herein, the specification unit 23 specifies the influence-destination object 33 in the operation data 31 as the object in which the operation representing the attack is detected. The specification unit 23 specifies the intrusion route by using the object specified as an origin, and tracing the direction represented by the direction information included in the relation data 51 in the reverse direction. The specification unit 23 specifies a range reached by tracing the direction in the reverse direction from the origin, as the intrusion route.

For example, it is assumed that the process B in FIG. 4 is an object in which an operation representing an attack is detected. In this case, the edge 53 being direction information is traced in the reverse direction, and the process A, the file A and the process B are specified as the intrusion route.

### (Step S24: Infected Range Specification Process)

The specification unit 23 refers to the relation data 51 constructed by the relation construction unit 22, and specifies an infected range supposed to be affected by the attack indicated in the operation data 31 accepted in Step S21.

Specifically, the specification unit 23 specifies an object in which an operation representing an attack indicated in the operation data 31 accepted in Step S21 is detected. Herein, the specification unit 23 specifies the influence-destination object 33 in the operation data 31 as the object in which the operation representing the attack is detected. The specification unit 23 specifies the infected range by using the object specified as an origin, and tracing the direction indicated in the direction information included in the relation data 51 in the forward direction. The specification unit 23 specifies a range reached by tracing the direction in the forward direction from the origin, as the infected range.

For example, it is assumed that the process B in FIG. 4 is an object in which an operation representing an attack is detected. In this case, the edge 53 being the direction information is traced in the forward direction, and the process B, the file B, the process C and the process D are specified as the infected range.

### (Step S25: Data Generation Process)

The specification unit 23 generates the intrusion route specified in Step S23, and output data representing the infected range specified in Step S24.

Specifically, the specification unit 23 generates data including a set of objects included in the intrusion route, and a set of objects included in the infected range, as the output data. The specification unit 23 may further include the edge 53 traced in Step S23 and the edge 53 traced in Step S24 in the output data.

Then, the specification unit 23 returns the process to Step S21, and waits for the next operation data 31 to be input.

### Effect of First Embodiment

As described above, the attack analysis device 10 according to First Embodiment adds the influence relation between objects due to the operation represented in the operation data 31 to the relation data 51 only when the operation is classified as “likely to be an attack” or “being an attack”. That is, the attack analysis device 10 according to First Embodiment adds the influence relation between the objects due to the operation indicated in the operation data 31 to the relation data 51 only when the probability of a cyber attack is more than a certain value.

In this manner, it is possible to specify only the objects which are highly likely to be related to a cyber attack as an intrusion route or an infected range. In other words, it is possible to not to specify an object that is unlikely to be related to a cyber attack as an intrusion route or an infected range.

Further, the attack analysis device 10 according to First Embodiment performs construction of the relation data 51 every time the operation data 31 is input. Then, the attack analysis device 10 according to First Embodiment is capable of specifying the intrusion route and the infected range immediately when the operation in the operation data 31 is decided as “being an attack”.

In this manner, it is possible to apply the attack analysis device 10 to a control system and the like which requires a real-time property.

### Other Configurations

### First Variation

In First Embodiment, each functional component is realized by software. However, as First Variation, each functional component may be realized by a hardware component. As for this First Variation, the part different from First Embodiment will be described.

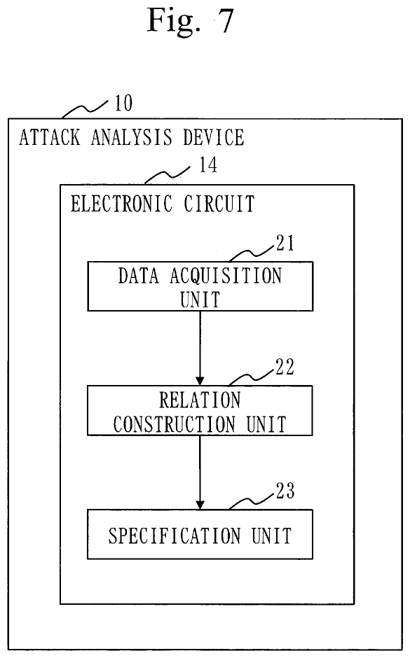

Description will be made on a configuration of the attack analysis device 10 according to First Variation with reference to FIG. 7.

When each functional component is realized by the hardware component, the attack analysis device 10 is equipped with an electronic circuit 14 instead of the processor 11, the memory unit 12 and the storage unit 13. The electronic circuit 14 is a dedicated circuit to realize each functional component, and the functions of the memory unit 12 and the storage unit 13.

As the electronic circuit 14, a single circuit, a composite circuit, a programmed processor, a parallel-programmed processor, a logic IC, a GA, an ASIC or an FPGA is supposed. GA is an abbreviation for Gate Array. ASIC is an abbreviation for Application Specific Integrated Circuit. FPGA is an abbreviation for Field-Programmable Gate Array.

Each functional component may be realized by one electronic circuit 14, or may be realized by a plurality of electronic circuits 14 dispersedly.

### Second Variation

As Second Variation, a part of each functional component may be realized by a hardware component, and the other part of each functional component may be realized by software.

The processor 11, the memory unit 12, the storage unit 13 and the electronic circuit 14 are called processing circuitry. That is, the functions of each functional component are realized by the processing circuitry.

### Second Embodiment

Second Embodiment is different from First Embodiment in that, also for operation data 31 with which the attack probability 34 is lower than the threshold value A, the influence relation between objects is added to the relation data 51, when an attack probability 34 is decided to be higher than a criterion based on the relation with other operation data 31. In Second Embodiment, this different part will be described, and description for the same parts will be omitted.

### Description of Operation

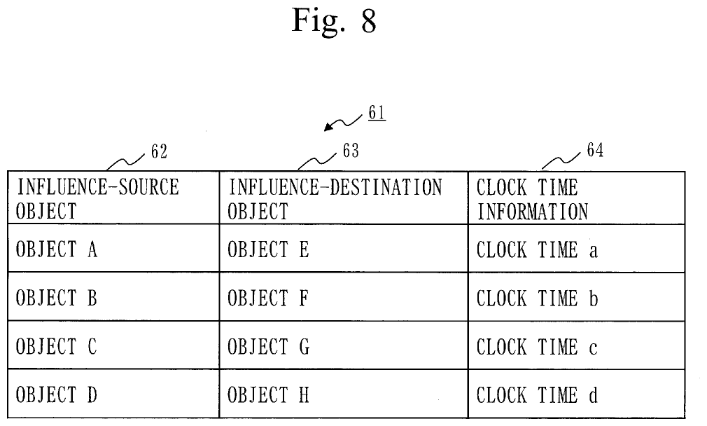

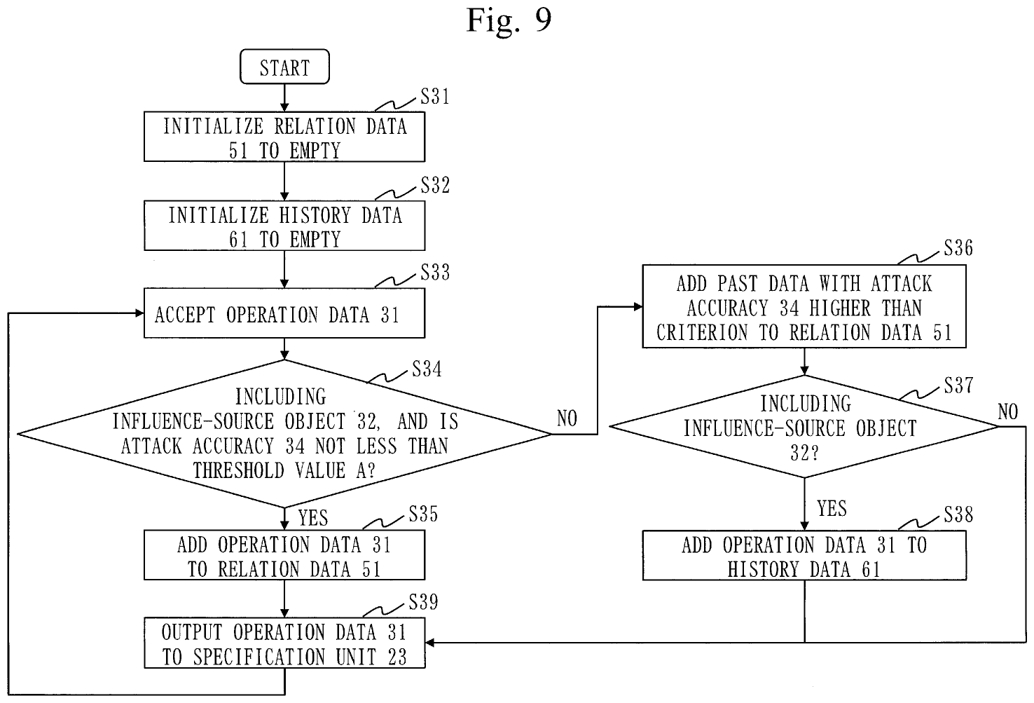

Description will be made on an operation of the attack analysis device 10 according to Second Embodiment with reference to FIG. 8 and FIG. 9.

The operation procedure of the attack analysis device 10 according to Second Embodiment corresponds to an attack analysis method according to Second Embodiment. Further, a program to realize the operation of the attack analysis device 10 according to Second Embodiment corresponds to an attack analysis program according to Second Embodiment.

Description will be made on a relation construction process after describing data and the like used in the relation construction process. The specification process is the same as that in First Embodiment.

Description will be made on history data 61 according to Second Embodiment with reference to FIG. 8.

The history data 61 is operation data 31 with which the attack probability 34 is lower than the threshold value A, and which includes the influence-source object 32, among operation data 31 input in the past.

The history data 61 includes an influence-source object 62, an influence-destination object 63 and clock time information 64.

The influence-source object 62 is an influence-source object 32 in the operation data 31 on which the history data 61 is based. The influence-destination object 63 is an influence-destination object 33 in the operation data 31 on which the history data 61 is based. The clock time information 64 indicates a clock time at which an operation represented by the operation data 31 on which the history data 61 is based is performed.

Description will be made on the relation construction process according to Second Embodiment with reference to FIG. 9.

The process of Step S31 the same as that of Step S11 in FIG. 5. The process from Step S33 through Step S35 is the same as that from Step S12 through Step S14 in FIG. 5. The process of Step S39 is the same as that of Step S15 in FIG. 5.

However, in Step S34, the relation construction unit 22 proceeds with the process to Step S35 when the operation data 31 includes the influence-source object 32, and the attack probability 34 is equal to or higher than the threshold value A. Meanwhile, in other cases, the relation construction unit 22 proceeds with the process to Step S36.

### (Step S32: History Data Initialization Process)

The relation construction unit 22 initializes the history data 61 to empty. That is, the relation construction unit 22 makes the history data 61 in a state of not including data.

### (Step S36: Second Data Addition Process)

The relation construction unit 22 extracts past data decided to have an attack probability 34 higher than the criterion based on the relation with operation data 31 newly acquired in Step S33 among past data being the operation data 31 included in the history data 61. It is considered that the relation construction unit 22 decides that the attack probability 34 of past data is higher than the criterion in cases of (1) and (2) as follows.
1) Case in which a first condition is met, and a second condition is met. The first condition is a condition that the attack probability 34 in the operation data 31 newly acquired is equal to or higher than the threshold value A. The second condition is a condition that a difference between an operation clock time of operation data 31 newly acquired and an operation clock time of the past data is within a reference time. The current time may be considered as the operation clock time of the operation data 31 newly acquired. The first condition may be omitted.
2) Case in which the first condition is met, and a third condition is met. The first condition is as described above. The third condition is a condition that at least either of the influence-source object and the influence-destination object is identical between the operation data 31 newly acquired and the past data. The third condition is met in a case either of (a) and (b) as follows. (a) The influence-source object 32 in the operation data 31 newly acquired is coincident with either of the influence-source object 62 or the influence-destination object 63 in the past data. (b) The influence-destination object 33 in the operation data 31 newly acquired is coincident with either of the influence-source object 62 or the influence-destination object 63 in the past data. The first condition may be omitted.

The relation construction unit 22 may decide that the attack probability 34 of the past data is higher than the criterion by using (1) and (2) together. That is, the relation construction unit 22 may decide that the attack probability 34 of the past data is higher than the criterion in a case in which the first condition is met, the second condition is met, and the third condition is met.

The relation construction unit 22 adds a relation between the influence-source object 62 and the influence-destination object 63 in the history data 61 extracted to the relation data 51. Specifically, the relation construction unit 22 adds an edge 53 directed to a node 52 corresponding to the influence-destination object 63 from a node 52 corresponding to the influence-source object 62 as direction information, to the relation data 51, as with the process of Step S14 in FIG. 5.

### (Step S37: Influence-Source Decision Process)

The relation construction unit 22 decides whether the operation data 31 newly acquired in Step S33 includes the influence-source object 62.

The relation construction unit 22 proceeds with the process to Step S38 when the influence-source object 62 is included. In other cases, the relation construction unit 22 proceeds with the process to Step S39.

### (Step S38: History Addition Process)

The relation construction unit 22 adds the operation data 31 newly acquired in Step S33 to the history data 61.

Specifically, the relation construction unit 22 newly creates a record in the history data 61. Then, the relation construction unit 22 writes the influence-source object 32 and the influence-destination object 33 in the operation data 31 into the influence-source object 62 and the influence-destination object 63 in the history data 61. The relation construction unit 22 writes the operation clock time of the operation data 31 into the clock time information 64 in the history data 61.

### Effect of Second Embodiment

As described above, the attack analysis device 10 according to Second Embodiment adds the influence relation between objects to the relation data 51 when the attack probability 34 is decided to be higher than the criterion based on the relation with other operation data 31.

There also exists an operation which cannot be decided as “being an attack” or “likely to be an attack” only with the operation data 31. Even this operation can be regarded as similar to an operation of “likely to be an attack”, and the relation data 51 can be constructed based on existence or absence of relevance to operations of “being an attack” or “likely to be an attack”.

### Third Embodiment

Third Embodiment is different from First Embodiment and Second Embodiment in that an attack probability 34 is calculated when operation data 31 does not included an attack probability 34. In Third Embodiment, this different part will be described, and description for the same parts will be omitted.

### Description of Configuration

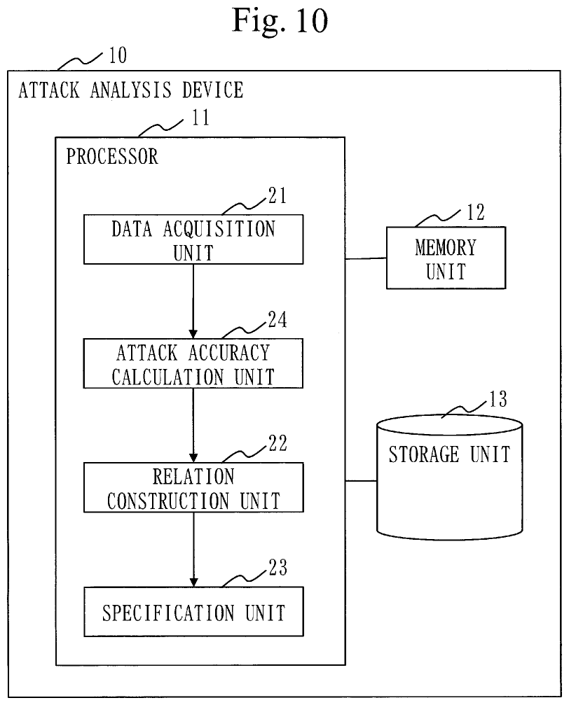

Description will be made on a configuration of the attack analysis device 10 according to Third Embodiment with reference to FIG. 10.

The attack analysis device 10 is different from the attack analysis device 10 illustrated in FIG. 1 in that it includes an attack probability calculation unit 24 as a functional component. The function of the attack probability calculation unit 24 is realized by software or a hardware component as with other functional components.

### Description of Operation

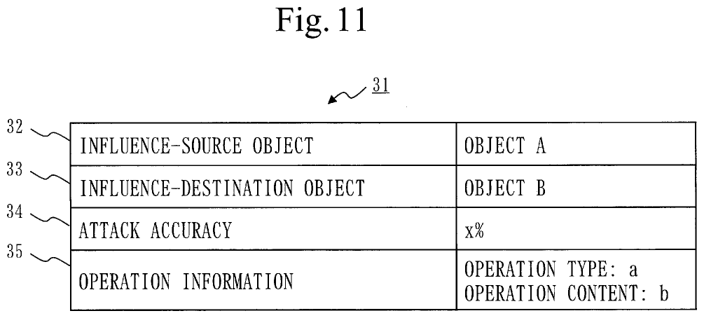

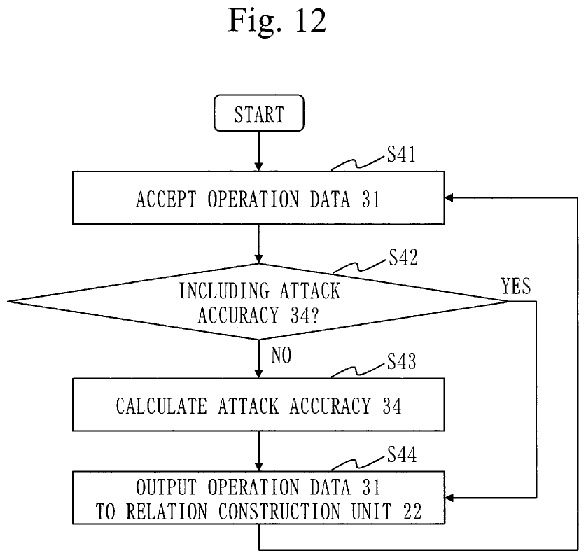

Description will be made on an operation of the attack analysis device 10 according to Third Embodiment with reference to FIG. 11 and FIG. 12.

The operation procedure of the attack analysis device 10 according to Third Embodiment corresponds to an attack analysis method according to Third Embodiment. Further, a program to realize the operation of the attack analysis device 10 according to Third Embodiment corresponds to an attack analysis program according to Third Embodiment.

The operation of the attack analysis device 10 includes an attack probability calculation process in addition to the relation construction process and the specification process. The attack probability calculation process will be described after describing data and the like used in the attack probability calculation process.

Description will be made on operation data 31 according to Third Embodiment with reference to FIG. 11.

The operation data 31 includes operation information 35 in addition to the influence-source object 32, the influence-destination object 33 and the attack probability 34.

The operation information 35 represents an operation type and an operation content. For example, the operation type is data transmission by socket communication. In this case, a port number, a data size and transmission data are included as the operation content. As another example, the operation type is writing on a file. In this case, a file path, a writing size, a writing position and writing data are included as the operation content.

Description will be made on the attack probability calculation process according to Third Embodiment with reference to FIG. 12.

### (Step S41: Operation Data Input Process)

The attack probability calculation unit 24 accepts new operation data 31 as an input. The concrete process is the same as that in Step S12 of FIG. 5.

### (Step S42: Data Decision Process)

The attack probability calculation unit 24 decides whether the operation data 31 accepted in Step S41 includes an attack probability 34.

The attack probability calculation unit 24 proceeds with the process to Step S43 when the operation data 31 does not include the attack probability 34. Meanwhile, in other cases, the attack probability calculation unit 24 proceeds with the process to Step S44.

### (Step S43: Probability Calculation Process)

The attack probability calculation unit 24 calculates an attack probability 34 from the operation content indicated in the operation information 35 in the operation data 31 accepted in Step S41. The attack probability calculation unit 24 adds the attack probability 34 calculated to the operation data 31.

Specifically, the attack probability calculation unit 24 sets a value of the attack probability 34 beforehand for each decision criterion. The decision criterion is set based on the operation content. The attack probability calculation unit 24 specifies a decision criterion which the operation content in the operation data 31 satisfies. The attack probability calculation unit 24 specifies a value of the attack probability 34 corresponding to the decision criterion specified.

A concrete example of the decision criterion will be described.

The operation type is assumed to be data transmission by socket communication. In this case, the decision criterion as follows is considered. First criterion: There is a possibility that the port number may be used for attack. Second criterion: The data size is different from what used in normal communication. Third criterion: The content of transmission data is coincident with or similar to that of known attack data.

The operation type is assumed to be file writing. In this case, a decision criterion as follows is considered. First criterion: Writing on a file that would not be written on in a normal operation is performed. Second criterion: The writing size is different from the writing size in a normal operation.

### (Step S44: Output Process)

The attack probability calculation unit 24 outputs the operation data 31 to the relation construction unit 22. Then, the attack probability calculation unit 24 returns the process to Step S41, and waits for the next operation data 31 to be input.

The relation construction process and the specification process are the same as those in First Embodiment and Second Embodiment. However, in the operation data input process (Step S12 in FIG. 5 and Step S33 in FIG. 9) in the relation construction process, the operation data 31 output in Step S44 is accepted.

### Effect of Third Embodiment

As described above, the attack analysis device 10 according to Third Embodiment calculates the attack probability 34 when the operation data 31 does not include the attack probability 34.

In this manner, even in the case in which the attack probability 34 is not specified beforehand, it is possible to acquire a similar effect as in First Embodiment and Second Embodiment.

Further, “unit” in the description above may be replaced with “circuit”, “step”, “procedure”, “process” or “processing circuitry”.

In the above, description has been made on the embodiments and the variations of the present disclosure. Some of these embodiments and variations may be combined and performed. Otherwise, any one or some may be partially performed. The present disclosure is not limited to the embodiments and the variations described above, and various modifications can be added as needed.

### REFERENCE SIGNS LIST

10: attack analysis device; 11: processor; 12: memory unit; 13: storage unit; 14: electronic circuit; 21: data acquisition unit; 22: relation construction unit; 23: specification unit; 24: attack probability calculation unit; 31: operation data; 32: influence-source object; 33: influence-destination object; 34: attack probability; 35: operation information; 41: threshold value; 51: relation data; 52: node; 53: edge; 61: history data; 62: influence-source object; 63: influence-destination object; 64: clock time information

1. An attack analysis device comprising
processing circuitry
to acquire operation data including at least an influence-destination object and an attack probability among an influence-source object being an object which has performed an operation to influence another object, the influence-destination object being an object which is influenced by the operation performed by the influence-source object, and the attack probability representing a probability of the operation being an attack;
to construct relation data when the operation data acquired includes the influence-source object, and the attack probability is equal to or higher than a threshold value A, by adding a relation between the influence-source object and the influence-destination object to the relation data; and
to specify at least either of an infected range which is supposed to be affected by an attack that is detected, and an intrusion route of the attack detected, based on the relation data constructed, when the attack is detected.

2. The attack analysis device as defined in claim 1, wherein the processing circuitry
adds, to the relation data, direction information indicating a direction from the influence-source object to the influence-destination object, as the relation between the influence-source object and the influence-destination object, and
specifies the infected range by using an object in which an operation indicating the attack detected is detected as an origin, and by tracing a direction indicated by the direction information included in the relation data in a forward direction.

3. The attack analysis device as defined in claim 2, wherein the processing circuitry specifies the infected range when the operation data is taken as an input, and the attack probability is equal to or higher than a threshold value B higher than the threshold value A, by using the influence-destination object as the object in which the operation indicating the attack detected is detected.

4. The attack analysis device as defined in claim 1, wherein the processing circuitry
adds direction information indicating a direction from the influence-source object to the influence-destination object, to the relation data, as the relation between the influence-source object and the influence-destination object, and
specifies the intrusion route by using the object in which an operation indicating the attack detected is detected as an origin, and by tracing a direction indicated by the direction information included in the relation data in a reverse direction.

5. The attack analysis device as defined in claim 4, wherein the processing circuitry
specifies the intrusion route when the operation data is taken as an input, and the attack probability is equal to or higher than a threshold value B higher than the threshold value A, by using the influence-destination object as the object in which the operation indicating the attack detected is detected.

6. The attack analysis device as defined in claim 1, wherein the processing circuitry adds, to the relation data, a relation between the influence-source object and the influence-destination object in past data of which the attack probability is decided to be higher than a criterion based on a relation with the operation data that is newly acquired, among past data being the operation data of which the attack probability is lower than the threshold value A.

7. The attack analysis device as defined in claim 6, wherein the processing circuitry decides that the attack probability of the past data is higher than the criterion when the attack probability in the operation data newly acquired is equal to or higher than the threshold value A, and a difference between an operation clock time of the operation data newly acquired and an operation clock time of the past data is within a reference time.

8. The attack analysis device as defined in claim 6, wherein the processing circuitry decides that the attack probability of the past data is higher than the criterion when the attack probability in the operation data newly acquired is equal to or higher than the threshold value A, and at least either of the influence-source object and the influence-destination object is identical between the operation data newly acquired and the past data.

9. The attack analysis device as defined in claim 1, wherein
the operation data includes operation information indicating an operation content, and
the processing circuitry calculates the attack probability from the operation content indicated in the operation information.

10. An attack analysis method comprising:
by a computer, acquiring operation data including at least an influence-destination object and an attack probability among an influence-source object being an object which has performed an operation to influence another object, the influence-destination object being an object which is influenced by the operation performed by the influence-source object, and the attack probability representing a probability of the operation being an attack;
by the computer, constructing relation data when the operation data includes the influence-source object, and the attack probability is equal to or higher than a threshold value A, by adding a relation between the influence-source object and the influence-destination object to the relation data; and
by the computer, specifying at least either of an infected range which is supposed to be affected by an attack that is detected, and an intrusion route of the attack detected, based on the relation data, when the attack is detected.

11. A non-transitory computer readable medium storing an attack analysis program to cause a computer to function as an attack analysis device performing:
a data acquisition process to acquire operation data including at least an influence-destination object and an attack probability among an influence-source object being an object which has performed an operation to influence another object, the influence-destination object being an object which is influenced by the operation performed by the influence-source object, and the attack probability representing a probability of the operation being an attack;
a relation construction process to construct relation data when the operation data acquired by the data acquisition process includes the influence-source object, and the attack probability is equal to or higher than a threshold value A, by adding a relation between the influence-source object and the influence-destination object to the relation data; and
a specification process to specify at least either of an infected range which is supposed to be affected by an attack that is detected, and an intrusion route of the attack detected, based on the relation data constructed by the relation construction process, when the attack is detected.
